(19) United States
(12) Patent Application Publication
(10) Pub. No.: US 2026/0114632 A1
(43) Pub. Date: Apr. 30, 2026

(54) MATTRESS FOR STRETCHING

(71) Applicant: TOYOTA JIDOSHA KABUSHIKI KAISHA, Toyota-shi (JP)

(72) Inventors: Kohshi KATOH, Hadano-shi (JP); Ryosuke TANAHASHI, Mishima-shi (JP); Michio ARAKAWA, Odawara-shi, (JP); Yukinori FUJITA, Toyokawa-shi (JP); Yasushi DOHNOUE, Seto-shi (JP); Masatoshi HADA, Nisshin-shi (JP)

(73) Assignee: TOYOTA JIDOSHA KABUSHIKI KAISHA, Toyota-shi, (JP)

(21) Appl. No.: 19/311,286

(22) Filed: Aug. 27, 2025

(30) Foreign Application Priority Data
Oct. 25, 2024 (JP) 2024-188590

(51) Int. Cl. A47C 27/00; A63B 23/02

(52) U.S. Cl. CPC A47C 27/001; A63B 23/02

(57) ABSTRACT

The mattress includes a first cushion member that is disposed on at least a head side of a user in a lying position and that generates a reaction force in a deflection direction intersecting a load input direction on the head side during use, and a second cushion member that is disposed on at least a foot side with respect to a head of the user M in the lying position and that generates a reaction force in a deflection direction intersecting the load input direction on the foot side during use.

### CROSS-REFERENCE TO RELATED APPLICATION

This application claims priority to Japanese Patent Application No. 2024-188590 filed on Oct. 25, 2024. The disclosure of the above-identified application, including the specification, drawings, and claims, is incorporated by reference herein in its entirety.

### BACKGROUND

### 1. Technical Field

The present disclosure relates to a mattress for stretching.

### 2. Description of Related Art

As an example of the related art relating to stretching, there is a stretching tool and a stretching method described in Japanese Unexamined Patent Application Publication No. 2018-82948 (JP 2018-82948 A) below. In the related art, a user hooks his or her fingers of both hands on a rod body of the stretching tool to stretch muscles in a state where the muscles are relaxed, and the muscles are gradually stretched by further changing the position of the rod body.

### SUMMARY

However, in the stretching tool according to the above-described related art, it is necessary to continue to hold a part of the body by, for example, gripping a holding portion with the fingers of both hands, in order to stretch the body, and thus the posture of the user may be restricted.

In consideration of the above-described circumstances, an object of the present disclosure is to obtain a mattress for stretching that can stretch a human body without restricting the posture of the user.

A mattress for stretching according to the present disclosure described in claim 1 includes:
a first cushion member disposed on at least a head side of a user in a lying position, the first cushion member being configured to generate, during use, a reaction force on the head side and in a deflection direction intersecting with a load input direction; and
a second cushion member disposed on a side closer to at least a foot side of the user in the lying position than a head of the user in the lying position is, the second cushion member being configured to generate, during use, a reaction force on the foot side and in a deflection direction intersecting with a load input direction.

According to the present disclosure described in claim 1, the first cushion member is disposed on at least the head side of the user in the lying position, and the second cushion member is disposed on the side closer to at least the foot side of the user in the lying position than the head of the user in the lying position is.

Here, in the present disclosure, the first cushion member generates, during use by the user, the reaction force on the head side of the user and in the deflection direction intersecting with the load input direction. On the other hand, the second cushion member generates, during use by the user, the reaction force on the foot side of the user and in the deflection direction intersecting with the load input direction. As a result, the body of the user in the lying position is stretched in directions opposite to each other between the first cushion member side and the second cushion member side, and the trunk of the user in the lying position is stretched.

According to the mattress of the present disclosure described in claim 2, in the disclosure described in claim 1, the first cushion member and the second cushion member include
a first mat base portion and a second mat base portion having substantially flat plate shapes and are disposed to face each other, and
a reaction force applying portion that is disposed between the first mat base portion and the second mat base portion to couple the first mat base portion and the second mat base portion in a substantially S-shaped pattern in a side view, and that is configured to be elastically deformable, the reaction force applying portion being configured to generate, during use by the user, the reaction force in the deflection direction intersecting with the load input direction.

According to the present disclosure described in claim 2, the reaction force applying portion is disposed between the first mat base portion and the second mat base portion of the first cushion member, and between the first mat base portion and the second mat base portion of the second cushion member. The reaction force applying portion couples the first mat base and the second mat base in a substantially S-shaped pattern in a side view, so that an elastic restoration force of the reaction force applying portion directly acts on a mat base on a side in contact with the user.

According to the mattress of the present disclosure described in claim 3, in the disclosure described in claim 1 or 2, a boundary between the first cushion member and the second cushion member is located at any one of a neck, a waist, and a leg.

According to the present disclosure described in claim 3, since the boundary between the first cushion member and the second cushion member is located at any one of the neck, the waist, and the leg, the trunk such as the neck, the waist, and the leg is stretched.

According to the mattress of the present disclosure described in claim 4, in the disclosure described in claim 1 or 2, at least one of the first cushion member and the second cushion member is divided into a plurality of pieces along a longitudinal direction of the mattress.

According to the present disclosure described in claim 4, at least one of the first cushion member and the second cushion member is divided into a plurality of pieces along the longitudinal direction of the mattress. Therefore, in a case where an orientation of the divided cushion member is reversed or changed by 180 degrees, an orientation of the reaction force acting on the body can be changed. In addition, the divided first cushion member and second cushion member can be stacked for storage.

According to the mattress of the present disclosure described in claim 5, in the disclosure described in claim 1, a pattern that enables the deflection direction of the reaction force to be identified is displayed on a surface of at least one of a first cover that covers the first cushion member and a second cover that covers the second cushion member.

According to the present disclosure described in claim 5, the first cushion member is covered with the first cover, and the second cushion member is covered with the second cover. By viewing the pattern on the surface of at least one of the first cover and the second cover, it is possible to identify which orientation is the deflection direction of the reaction force of the cushion member.

As described above, the mattress according to the present disclosure described in claim 1 has an excellent effect in that a human body can be stretched without restricting the posture of the user.

The mattress according to the present disclosure described in claim 2 has an excellent effect in that a target part can be efficiently stretched.

The mattress according to the present disclosure described in claim 3 has an excellent effect in that a blood flow of the trunk such as the neck, the waist, and the leg is improved, and thus a fatigue-reducing effect, a lower back pain preventing or relieving effect, and the like can be expected.

The mattress according to the present disclosure described in claim 4 has an excellent effect in that a part to be stretched can be adjusted and a storage space can be reduced.

The mattress according to the present disclosure described in claim 5 has an excellent effect in that the first cushion member and the second cushion member can be easily and quickly disposed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a longitudinal cross-sectional view of a cushion that schematically shows a model in which a deflection reaction force acts in a case in which a load of a user acts on the cushion in a mattress according to the present embodiment;

FIG. 1B is a perspective view of the cushion that shows a basic structure of the cushion;

FIG. 1C is an enlarged side view of the cushion in a no-load state of FIG. 1B as viewed from a width direction;

FIG. 1D is an enlarged side view of the cushion in a state in which a load is applied from the state of FIG. 1C as viewed from the width direction;

FIG. 2 is a perspective view showing the mattress according to the present embodiment in a usage state;

FIG. 3 is a longitudinal cross-sectional view of the mattress that shows an example in which the mattress shown in FIG. 2 is provided such that a boundary of a reaction force is located at a waist of the user;

FIG. 4A is a reaction force display plan view showing a direction of an in-plane reaction force in a case in which the boundary of the reaction force is set to a neck in the mattress shown in FIG. 2;

FIG. 4B is a reaction force display plan view showing a direction of an in-plane reaction force in a case in which the boundary of the reaction force is set to the waist;

FIG. 4C is a reaction force display plan view in a case in which the boundary of the reaction force is set to a leg;

FIG. 5A is a reaction force display side view of a case in which the boundary of the reaction force of the mattress according to the present embodiment is set to the waist;

FIG. 5B is a reaction force display side view of a case in which the boundary of the reaction force is set to a back; and

FIG. 5C is a side view of a state in which the mattresses in the present embodiment are stacked for storage.

### DETAILED DESCRIPTION OF EMBODIMENTS

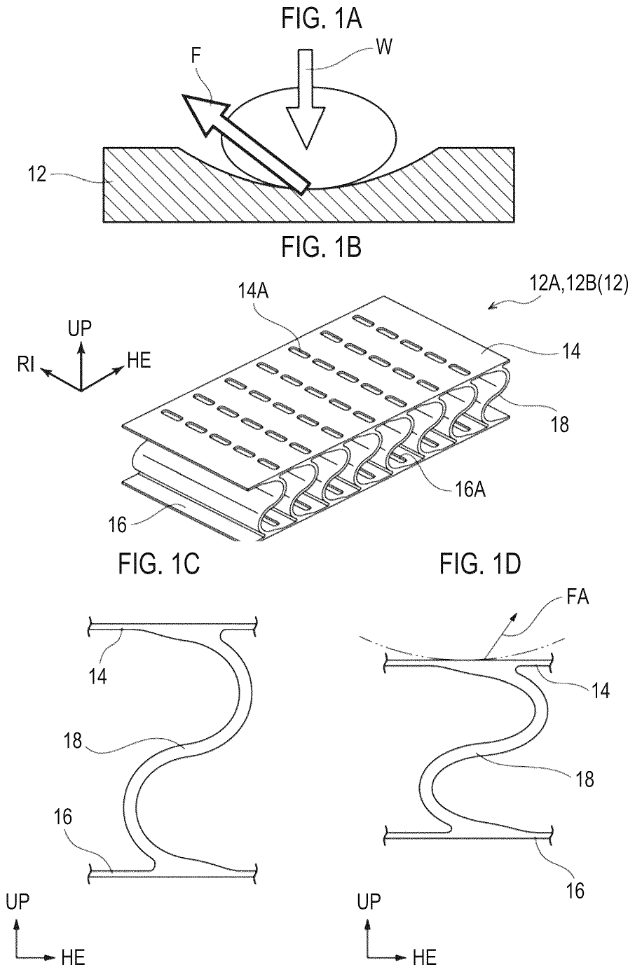

Hereinafter, a mattress 10 according to the present embodiment will be described with reference to FIGS. 1A to 5C. It should be noted that an arrow UP that is appropriately shown in each drawing indicates an upward direction with respect to the mattress 10 placed on a floor or the like, an arrow HE indicates a head side direction of the user in a mattress longitudinal direction, and an arrow RI indicates a right side direction of the user in a mattress lateral direction.

### Overall Structure of Mattress 10

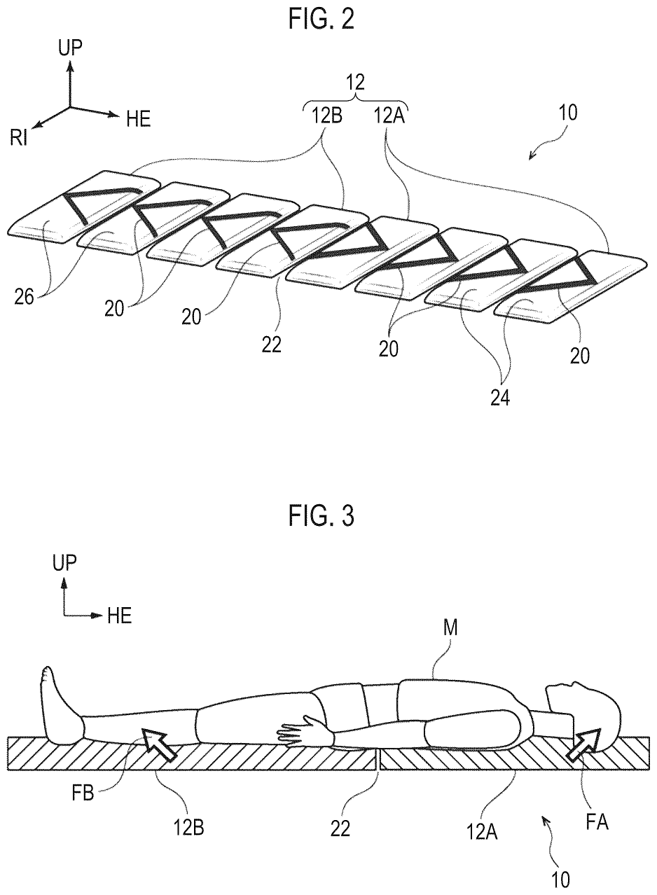

As shown in FIG. 2, the mattress 10 as a mattress for stretching according to the present embodiment is used, for example, by being placed on a floor (not shown). The mattress 10 is configured by a plurality of cushions 12. The cushion 12 is configured by a cushion 12A as a first cushion member and a cushion 12B as a second cushion member. In this embodiment, the cushion 12A and the cushion 12B are each formed of four pieces. It should be noted that, in the following description, in a case in which the cushion 12 is described in a reaction force application direction, the cushion 12 is referred to as the “cushion 12A” and the “cushion 12B”, and in a case in which it is not necessary to distinguish between the cushions 12, the cushion 12 may be simply referred to as the “cushion 12”.

In the example shown in FIG. 3, the mattress 10 has a total length that is slightly longer than a height of an adult user with a standard physique, the cushion 12A mainly supports a head to the waist, and the cushion 12B supports from a buttock to a toe.

As shown in FIG. 1A, each cushion 12 is configured to generate a reaction force F that is deflected with respect to a load W from above. As shown in FIG. 3, the mattress 10 is capable of supporting an occiput, a back, a waist, and a leg of a user M in a supine posture state. The mattress 10 includes the cushion 12A that generates a reaction force FA toward the head side and the cushion 12B that generates a reaction force FB toward the leg side.

In addition, as shown in FIG. 2 and the like, the mattress 10 is formed such that an orientation of the disposed cushion 12 can be changed. That is, the cushions 12 are formed to have the same width, length, and thickness, and the reaction force application direction can be changed by reversing each cushion 12 or rotating each cushion 12 by 180 degrees in the same plane.

### Main Part Structure of Mattress 10

FIG. 1B is an enlarged perspective view showing the inside of the cushion 12 in the present embodiment in an enlarged manner. It should be noted that, in the present embodiment, the eight cushions 12 have the same structure as an example.

As shown in FIG. 1B, the cushion 12 includes a first mat base portion 14 having a flat plate shape, a second mat base portion 16 having a flat plate shape, and a reaction force applying portion 18. The first mat base portion 14 extends in a mattress width direction and a mattress length direction. The second mat base portion 16 is disposed on a side opposite to the first mat base portion 14. The reaction force applying portion 18 connects the first mat base portion 14 and the second mat base portion 16 in a mattress thickness direction.

A plurality of through-holes 14A are provided in the first mat base portion 14. Each through-hole 14A is formed in a substantially long hole shape having a sheet width direction as a longitudinal direction, and is disposed at an equal interval in the mattress width direction. The through-holes 14A are provided at an equal interval in the mattress length direction.

The second mat base portion 16 has the same shape as the first mat base portion 14 and is disposed at a predetermined interval in the mattress thickness direction from the first mat base portion 14. In addition, a through-hole 16A is provided in the second mat base portion 16 in the same manner as in the first mat base portion 14.

The reaction force applying portion 18 is formed such that a cross-sectional shape seen from the mattress width direction is a substantially S-shaped pattern. In addition, the reaction force applying portions 18 are provided at an equal interval with a predetermined interval in the mattress length direction, and each reaction force applying portion 18 extends from a first end portion to a second end portion of the cushion 12 in the mattress width direction. As shown in FIGS. 2 and 3, in a case of the cushion 12A, the reaction force applying portion 18 is curved toward the head side from the first mat base portion 14 toward the second mat base portion 16, and then is curved toward the leg side to have a substantially S-shaped pattern. As a result, the cushion 12A generates the reaction force FA toward the head side. In a case of the cushion 12B, the opposite is applied.

More specifically, FIGS. 1C and 1D are enlarged cross-sectional views of a main part showing the cross section of the reaction force applying portion 18 in an enlarged manner, FIG. 1C shows the reaction force applying portion 18 in a no-load state, and FIG. 1D shows the reaction force applying portion 18 in a compressed state. In the no-load state shown in FIG. 1C, in a case in which the first mat base portion 14 side is pressed by the body of the user M in a state in which the second mat base portion 16 is installed on the floor or the like, the reaction force applying portion 18 is elastically deformed in a compression direction and the state thereof transitions to the compressed state shown in FIG. 1D. That is, a distance between the first mat base portion 14 and the second mat base portion 16 is shortened by the compression deformation of the reaction force applying portion 18.

Here, in the state shown in FIG. 1D, the reaction force FA directed upward of the mattress 10 and toward the head side acts on the body of the user M from the first mat base portion 14 as indicated by an arrow in the drawing. That is, the cushion 12A is configured to apply the reaction force FA toward the head side of the mattress 10 to the head, the back, and the waist of the user M in contact with the cushion 12A.

On the other hand, in a case in which the cushion 12 shown in FIG. 1C is disposed to be reversed or to face an orientation opposite by 180 degrees, the orientation of the reaction force applying portion 18 is reversed. In this state, since the second mat base portion 16 is located on a user side, the second mat base portion 16 is pressed toward the first mat base portion 14 side. As a result, the reaction force FB (see FIG. 3) directed upward of the mattress 10 and toward the leg side acts on a rider from the second mat base portion 16. That is, the cushion 12B is provided with the reaction force F acting in an opposite direction, only by disposing the reaction force applying portion 18 of the cushion 12A in a reversed orientation.

In addition, as shown in FIG. 2, the cushions 12 are disposed in the intermediate portion of the mattress 10 such that the reaction forces F are opposite to each other. Specifically, the mattress 10 is configured by four cushions 12A continuously disposed on the head side and four cushions 12B continuously disposed on the leg side. The cushions 12A and 12B are covered with covers 24 and 26. Further, a mountain-shaped (V-shaped) pattern 20 is displayed on the front and back surfaces of each of the covers 24 and 26 such that the directions in which the reaction force FA and the reaction force FB act can be visually determined.

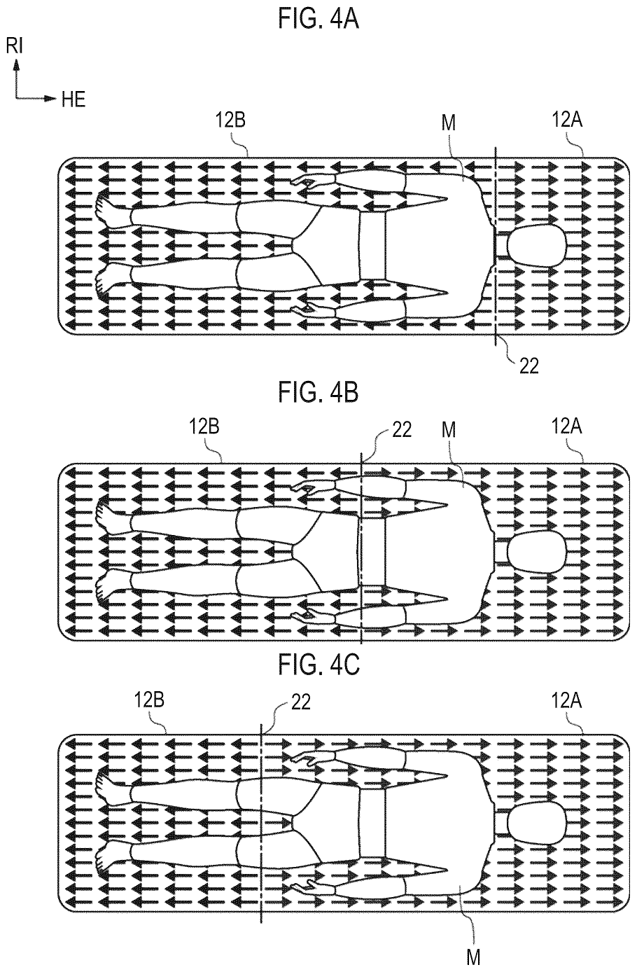

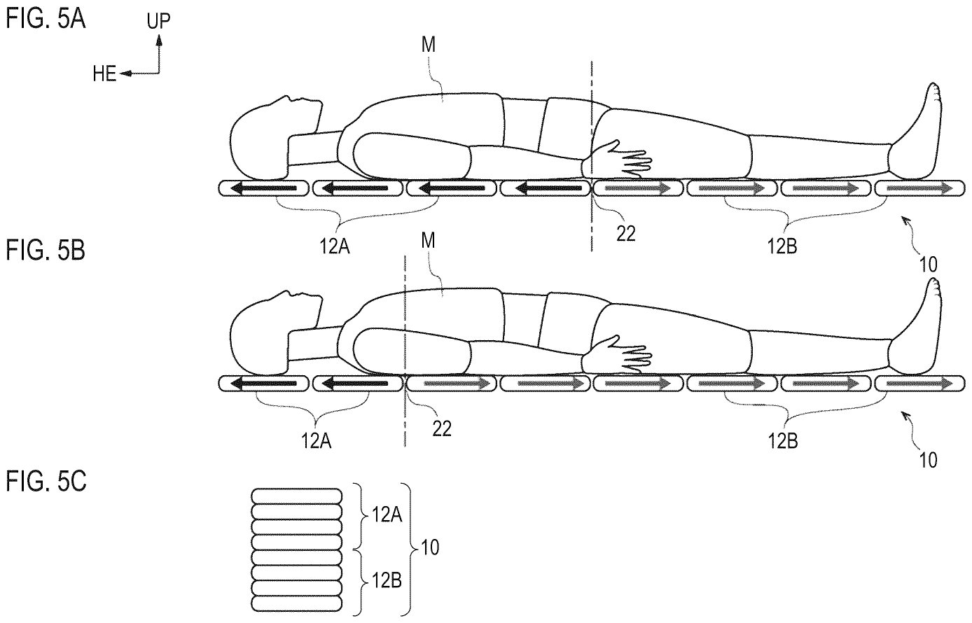

In addition, as shown in FIGS. 4A to 4C and FIGS. 5A and 5B, it is possible to change a position of a boundary portion 22 at which the action direction of the reaction force Fis deflected, by changing the disposition of the cushions 12A and 12B of the mattress 10. Specifically, a disposition in which the boundary portion 22 is located at the neck (see FIG. 4A) can be adopted. By disposing the cushions 12 in a reversed manner, it is possible to adopt a disposition in which the boundary portion 22 is located at the waist (see FIGS. 4B and 5B). A disposition in which the boundary portion 22 is located at the leg (see FIG. 4C) can be adopted.

Further, as shown in FIG. 5C, since the cushions 12A and 12B constituting the mattress 10 are formed to have the same size, the cushions 12A and 12B can be stacked for compact storage.

### Actions and Effects of Present Embodiment

Next, the actions and the effects of the mattress 10 according to the present embodiment will be described.

With the mattress 10 according to the present embodiment, the cushion 12A is disposed on at least the head side of the user M in the lying position, and the cushion 12B is disposed on at least the foot side with respect to the head of the user M in the lying position.

Here, in the present embodiment, the cushion 12A generates the reaction force FA in the deflection direction intersecting the load input direction on the head side of the user M during use of the user M. On the other hand, the cushion 12B generates the reaction force FB in the deflection direction intersecting the load input direction on the foot side of the user M during use of the user M. As a result, the body of the user M in the lying position is stretched in directions opposite to each other between the cushion 12A side and the cushion 12B side, and the trunk of the user M in the lying position is stretched. As a result, the mattress 10 according to the present embodiment can stretch the human body without restricting the posture of the user M.

In addition, in the present embodiment, a plurality of reaction force applying portions 18 are disposed between the first mat base portion 14 and the second mat base portion 16 of the cushion 12. By connecting the reaction force applying portions 18 in a substantially S-shaped pattern in a side view, an elastic restoration force of the reaction force applying portion 18 directly acts on the mat base portion on a side in contact with the user M. As a result, the mattress 10 according to the present embodiment can efficiently stretch a target part.

Further, in the present embodiment, since the boundary portion 22 that is a boundary between the cushion 12A and the cushion 12B is any one of the neck, the waist, or the leg, the trunk such as the neck, the waist, or the leg is stretched. As a result, with the mattress 10 according to the present embodiment, the blood flow of the trunk such as the neck, the waist, or the leg is improved, and thus a fatigue reduction effect, a lower back pain prevention/improvement effect, and the like can be expected.

In addition, in the present embodiment, since the cushion 12A and the cushion 12B are divided into a plurality of pieces in the mattress longitudinal direction, in a case in which the orientation of the divided cushion 12 is reversed or rotated by 180 degrees, the orientation of the reaction force F acting on the body can be changed. The divided cushion 12 can be stacked for storage. As a result, the mattress 10 according to the present embodiment can adjust a part to be stretched and can reduce a storage space.

Further, in the present embodiment, the cushions 12A and 12B are covered with the covers 24 and 26, and the pattern 20 capable of identifying the deflection direction of the reaction force is displayed on the front and back surfaces of the covers 24 and 26. Therefore, by viewing the pattern 20, it is possible to view the deflection direction of the reaction force of the cushions 12A and 12B. As a result, the mattress 10 according to the present embodiment can easily and quickly dispose the cushions 12A and 12B.

It should be noted that, in the present embodiment, both the cushions 12A and 12B are divided into a plurality of pieces, but the present disclosure is not limited thereto, and a configuration may adopted in which only one of the cushion 12A or the cushion 12B is divided.

In addition, in the present embodiment, the pattern 20 is applied to the front and back surfaces of both of the covers 24, 26, but the present disclosure is not limited thereto, and the pattern 20 may be applied to only one of the covers 24, 26. Further, the pattern 20 may be applied only to the front surface instead of the front and back surfaces.

What is claimed is:

1. A mattress for stretching, the mattress comprising:
a first cushion member disposed on at least a head side of a user in a lying position, the first cushion member being configured to generate, during use, a reaction force on the head side and in a deflection direction intersecting with a load input direction; and
a second cushion member disposed on a side closer to at least a foot side of the user in the lying position than a head of the user in the lying position is, the second cushion member being configured to generate, during use, a reaction force on the foot side and in a deflection direction intersecting with a load input direction.

2. The mattress according to claim 1,
wherein the first cushion member and the second cushion member include
a first mat base portion and a second mat base portion having substantially flat plate shapes and are disposed to face each other, and
a reaction force applying portion that is disposed between the first mat base portion and the second mat base portion to couple the first mat base portion and the second mat base portion in a substantially S-shaped pattern in a side view, and that is configured to be elastically deformable, the reaction force applying portion being configured to generate, during use by the user, the reaction force in the deflection direction intersecting with the load input direction.

3. The mattress according to claim 1, wherein a boundary between the first cushion member and the second cushion member is located at any one of a neck, a waist, and a leg.

4. The mattress according to claim 1, wherein at least one of the first cushion member and the second cushion member is divided into a plurality of pieces along a longitudinal direction of the mattress.

5. The mattress according to claim 1, wherein a pattern that enables the deflection direction of the reaction force to be identified is displayed on a surface of at least one of a first cover that covers the first cushion member and a second cover that covers the second cushion member.
